(19) United States
(12) Patent Application Publication
(10) Pub. No.: US 2005/0276489 A1
(43) Pub. Date: Dec. 15, 2005

(54) Picture compressor and picture reproducer

(75) Inventor: Takashi Ishikawa, Tokyo (JP)

Correspondence Address: OSTROLENK FABER GERB & SOFFEN, 1180 AVENUE OF THE AMERICAS, NEW YORK, NY, 100368403, US

(73) Assignee: Olympus Corporation

(21) Appl. No.: 11/146,670

(22) Filed: Jun. 7, 2005

(30) Foreign Application Priority Data
Jun. 14, 2004 (JP) 2004-176098

(51) Int. Cl. G06K 9/36

(52) U.S. Cl. 382/232

(57) ABSTRACT

A picture compression apparatus comprises a division device for dividing picture data composed of a plurality of two-dimensionally arrayed pixels into units composed of m×n (m and n: arbitrary positive numbers) pixels; a unit code attaching device for attaching a same code to the unit if the pixel value of each color component in the unit is the same, and for attaching a different code to the unit if the pixel value of each color component in the unit is different; and a compression device for applying a predetermined compression process to pixel data corresponding to the unit code attached by the unit code attaching device and the unit code.

### CROSS REFERENCE TO RELATED APPLICATION

This application is based on and claims the benefit of priority from the prior Japanese Patent Application No. 2004-176098 field in Japan on Jun. 14, 2004, the entire contents of which are incorporated by this reference.

### BACKGROUND OF THE INVENTION

1. Field of the Invention

The present invention relates to the compression/expansion of picture data.

2. Description of the Related Art

Conventionally, when compressing a natural picture with a plurality of color components reversibly, the natural picture is often compressed together with the color components in order to enhance the correlation with an adjacent pixel. Alternatively, the natural picture is often compressed after reversible color conversion is applied. In computer graphics where the number of colors is restricted or the like, the same color is represented by one value using a look-up table and the amount of data is reduced.

As a method for reversibly compressing a picture shot by a digital still camera, there is raw compression. The raw compression is a method for compressing data read from an imaging device without degrading picture quality. However, when raw-compressing a picture shot by a digital still camera, a compression rate cannot be enhanced so much by the influence of noise due to an imaging system or the like. For that reason, a method for compressing only higher-order bits with a high correlation with an adjacent pixel reversibly, using a DPCM method (for example, Japanese Patent Application Laid-open Nos. 2000-244922 and 2001-060876). The DPCM method can reduce the amount of information by utilizing the fact that there is a strong correlation between the picture information of a center pixel to be encoded and that of a surrounding pixel. In these methods, its correlation with an adjacent pixel is enhanced by dividing a Bayer structure into color components.

### SUMMARY OF THE INVENTION

The picture compression apparatus of the present invention comprises
a division device for dividing picture data composed of a plurality of two-dimensionally arrayed pixels into units composed of m×n (m and n are arbitrary positive numbers) pixels,
a unit code attaching device for attaching a same code to the unit if the pixel value of each color component in the unit is the same, and for attaching a different code to the unit if the pixel value of each color component in the unit is different, and
a compression device for applying a predetermined compression process to pixel data corresponding to a unit code attached by the unit code attaching device and the unit code.

Another picture compression apparatus of the present invention comprises
a division device for dividing picture data into units composed of a predetermined number of pixels,
a palette data generation device for generating palette data containing the pixel value of each color component in the unit and a unit code attached according to its distribution,
a unit data generation device for generating unit data in which the picture data divided into units is expressed by a unit code corresponding to the pixel value of each color component of the unit, and
a compression device for compressing the palette data and the unit data.

A reproduction apparatus of the present invention comprises
an expansion device for dividing picture data composed of a plurality of two-dimensionally arrayed pixels into units composed of m×n (m and n: arbitrary positive numbers) pixels, and attaching a same code to the unit if the pixel value of each color component in the unit is the same, and a different code to the unit if the pixel value of each color component in the unit is different, and expanding compressed data in which a predetermined compression process is applied to pixel data corresponding to the attached unit code and the unit code; and
a reproduction device for reproducing the picture data, based on the unit code expanded by the expansion device and pixel data corresponding to the unit code.

Another picture reproduction apparatus of the present invention comprises
an expansion device for dividing picture data into units composed of a predetermined number of pixels, generating palette data containing the pixel value of each color component of the unit and a unit code attached according to its distribution, generating unit data in which the picture data divided into units is expressed by a unit code corresponding to the pixel value of each color component of the unit and expanding data obtained by compressing the palette data and the unit data; and
a reproduction device for reproducing the picture data, based on the palette data and the unit data which are expanded by the expansion device.

Another picture reproduction apparatus comprises
an expansion device for dividing each piece of pixel data which constitutes picture data and is composed of a predetermined number of bits into higher-order pixel data composed of higher-order bits and lower-order pixel data composed of lower-order bits, dividing the picture data into units composed of a predetermined number of pixels, generating higher-order pixel palette data containing the pixel value of each higher-order color component of the unit and a unit code attached according to its distribution, generating higher-order pixel unit data in which the picture data divided into units is expressed by a unit code corresponding to the pixel value of each higher-order color component of the unit and expanding data obtained by compressing the higher-order palette data and the higher-order unit data; and
a reproduction device for reproducing the picture data, based on the higher-order pixel palette data, the higher-order pixel unit data and the lower-order pixel data.

Another picture reproduction apparatus comprises
an expansion device for dividing each piece of pixel data which constitutes picture data composed of a predetermined number of bits into higher-order pixel data composed of higher-order bits and lower-order pixel data composed of lower-order bits, dividing the picture data into units composed of a predetermined number of pixels, generating higher-order pixel palette data containing the pixel value of each higher-order color component of the unit and a unit code attached according to its distribution, generating higher-order pixel unit data in which the picture data divided into units is expressed by a unit code corresponding to the pixel value of each higher-order color component of the unit and expanding data obtained by compressing the higher-order palette data, the higher-order unit data and the lower pixel data; and
a reproduction device for reproducing the picture data, based on the higher-order pixel palette data, the higher-order pixel unit data and the lower-order pixel data.

### BRIEF DESCRIPTION OF THE DRAWINGS

FIG. 1 is a basic flowchart showing the compression process of picture data of the present invention.

FIG. 2 shows an example of the Bayer unit picture of the present invention.

FIG. 3 shows an example of the palette data of the present invention.

FIG. 4 shows the unit data of the present invention.

FIG. 5 shows an example of picture data obtained by dividing a picture composed of more number of pixels than the picture shown in FIG. 2.

FIG. 6A shows palette data corresponding to the area 1 shown in FIG. 5.

FIG. 6B shows palette data corresponding to the area 2 shown in FIG. 5.

FIG. 6C shows palette data corresponding to the area d shown in FIG. 5.

FIG. 7 shows the configuration of the picture compression apparatus in the first preferred embodiment.

FIG. 8 shows one example of the hardware environment of the picture compression apparatus in the first preferred embodiment.

FIG. 9 is a flowchart showing the compression (encoding) process in the first preferred embodiment.

FIG. 10 shows the configuration of the picture reproduction apparatus in the second preferred embodiment.

FIG. 11 is a flowchart showing the expansion process in the second preferred embodiment.

FIG. 12 shows one example of bit division in the third preferred embodiment.

FIG. 13 shows the configuration of the picture compression apparatus in the third preferred embodiment.

FIG. 14 is a flowchart showing the compression (encoding) process in the third preferred embodiment.

FIG. 15 shows the configuration of the picture reproduction apparatus in the fourth preferred embodiment.

FIG. 16 is a flowchart showing the expansion process in the fourth preferred embodiment.

### DESCRIPTION OF THE PREFERRED EMBODIMENTS

In the case of a natural picture in which correlation with an adjacent pixel is high, it is expected that the correlation of an adjacent pixel value or an adjacent pixel value for each Bayer structure unit is high in all color components. In particular, as to the higher-order bit of a pixel value, there is a possibility that the bit components of all color components may become the same.

However, in the conventional method, if the correlation between the higher-order bits of a color component is strong, the degree of redundancy is not taken into consideration so much.

In the present invention, in a picture containing a plurality of color components in a frame, such as a multi-component picture (full-color picture), a Bayer picture and the like, the overlap of colors can be eliminated and compression efficiency can be improved.

The present invention divides picture data composed of two-dimensionally arrayed pixel data into a plurality of units, attaches a unit code according to the pixel value of each color component in the unit and decodes picture data in which a predetermined compression process has been applied to the unit code. The present invention is described below.

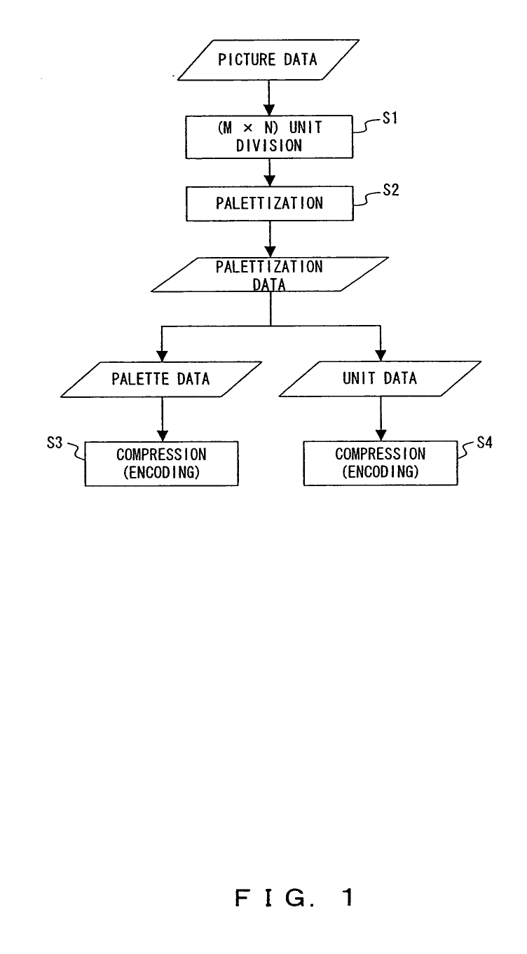

FIG. 1 is a basic flowchart showing the compression process of picture data of the present invention. The contents of the present invention are described using picture data composed of Bayer arrays as one example.

Firstly, picture data is divided into m×n units (step S1, hereinafter a step is called “S”). Division into m×n units means to divide picture data into a plurality of units each with m×n pixels (m and n: arbitrary positive numbers).

Then, palettization is applied to the unit picture data (S2). Here palettization is described. One unit is composed of m×n pixels, and one pixel is expressed by k gradations (k: arbitrary positive number). Therefore, one unit is composed of k^{mn} pattern components (pixel distributions). Of these, a unique code is attached to each pixel distribution of a predetermined number of patterns, which is described later. This is called “palettization”.

When palettization is applied in S2, palettization data is generated. The palettization data is composed of palette data and unit data. The gradation value of each pixel constituting a divided unit is stored in palette data, which is described later. Unit data is obtained by replacing unit picture data with a unit code.

Then, compression (encoding) is applied to each of the palette data and unit data (S3 and S4).

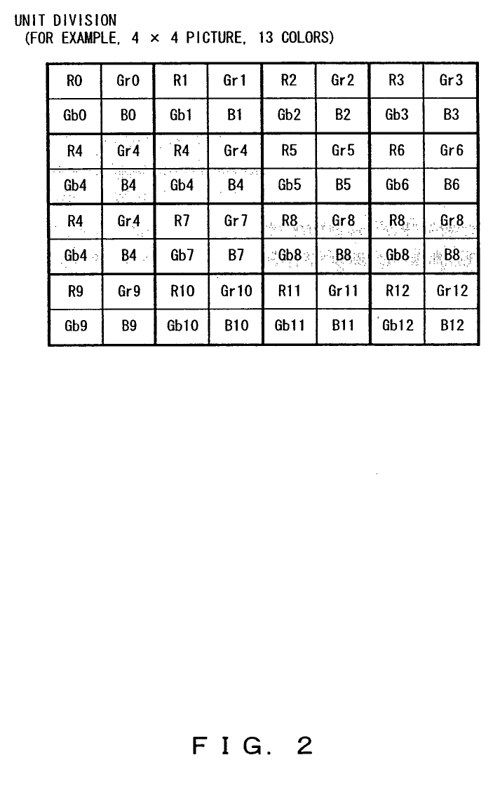

FIG. 2 shows an example of the Bayer unit picture of the present invention. A Bayer picture is expressed using 2×2 pixels (red (R), green (Gr), green (Gb) and blue (B)) as one set. In the present invention, one unit composed of 2×2 pixels. Then, a Bayer picture is composed of vertical 4 units×horizontal 4 units=16 units.

The pixel distribution of each unit is sequentially seen from a left top corner to a right bottom corner as follows.

(R0,Gr0, Gb0, B0), (R1, Gr1, Gb1, B1), (R2, Gr2, Gb2, B2), (R3, Gr3, Gb3, B3), (R4, Gr4, Gb4, B4), (R4, Gr4, Gb4, B4), (R5, Gr5, Gb5, B5), (R6, Gr6, Gb6, B6), (R4, Gr4, Gb4, B4), (R7, Gr7, Gb7, B7), (R8, Gr8, Gb8, B8), (R8, Gr8, Gb8, B8), (R9, Gr9, Gb9, B9), (R10, Gr10, Gb10, B10), (R11, Gr11, Gb11, B11), (R12, Gr12, Gb 11, B12).

Each of R0, R1, R2, . . . indicates the pixel value of a red color component (called a “R pixel value”). Each of Gr0, Gr1, Gr2, . . . and Gb0, Gb1, Gb2, . . . indicates the pixel value of a green color component (they are called a “Gr pixel value” and a “Gb pixel value”, respectively. Each of B0, B1, B2, . . . indicates the pixel value of a blue color component (called a “B pixel value”).

In FIG. 2, one unit is composed of four pixels of R, Gr, Gb and B each of which is composed of 2×2 pixels. Each pixel of these has a gradation value. Therefore, the color of one unit is expressed by the four pixel components (component ratio of a gradation value) of four pixels. In the following description, the pixel component of one unit is called a “pixel distribution”. FIG. 2 shows a picture composed of 13 colors.

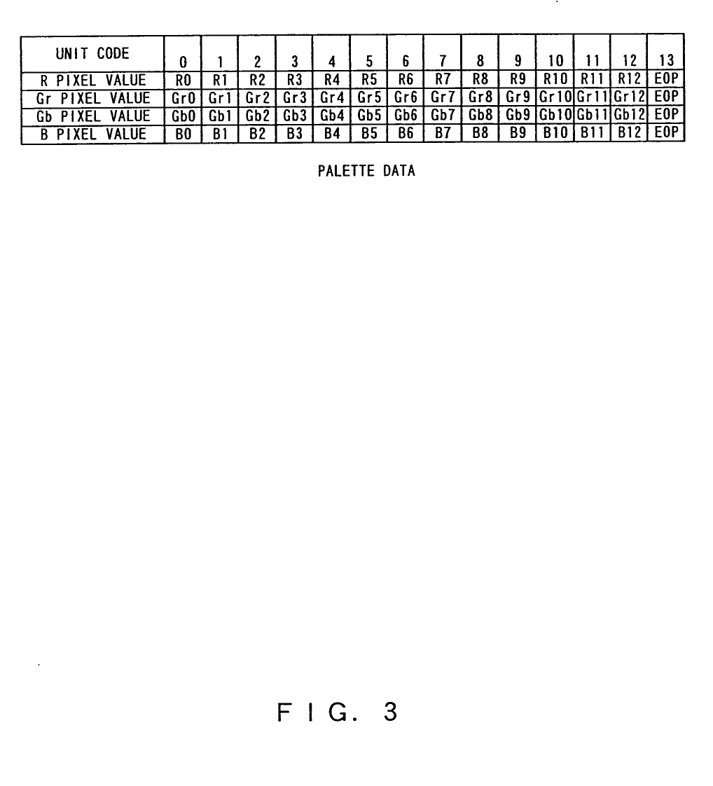

FIG. 3 shows an example of the palette data of the present invention. The palette data is one of the unit pictures shown in FIG. 2. The palette data is composed of an R pixel value, a Gr pixel value, a Gb pixel value and a B pixel value, which are the color components of a unit, and a unit code for uniquely managing this pixel distribution. In FIG. 3, unit codes 0, 1, 2, 3, 4, . . . ,12 are attached to (R0, Gr0, Gb0, B0), (R1, Gr01, Gb1, B1), (R2, Gr2, Gb2, B2), (R3, Gr3, Gb3, B3), (R4, Gr4, Gb4, B4), . . . , (R12, Gr12, Gb12, B12), respectively.

As to unit code 13, EOP (end of palette) is stored in each of the R pixel value, Gr pixel value, Gb pixel value of B pixel value. EOP indicates the end of one palette.

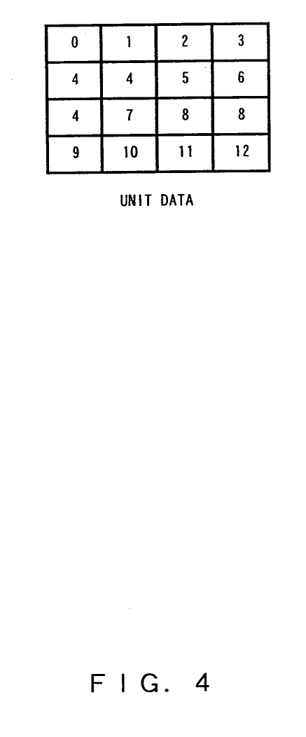

FIG. 4 shows the unit data obtained by dividing the picture shown in FIG. 2 into units, based on the palette data shown in FIG. 3. Specifically, the unit data is obtained by replacing the unit picture data (FIG. 2) with the unit code (FIG. 3). Since the unit in the left top corner of the picture shown in FIG. 2 is (R0, Gr0, Gb0, B0), the unit can be “0” if it is expressed by a unit code referring to the palette data shown in FIG. 3. Since a unit located right to the unit is (R1, Gr1, Gb1, B1), its unit code becomes “1”. FIG. 4 can be obtained by applying this process to all units constituting the picture shown in FIG. 2.

The unit code EOP of the unit code 13 is attached next to data obtained by arraying the unit codes in scanning order.

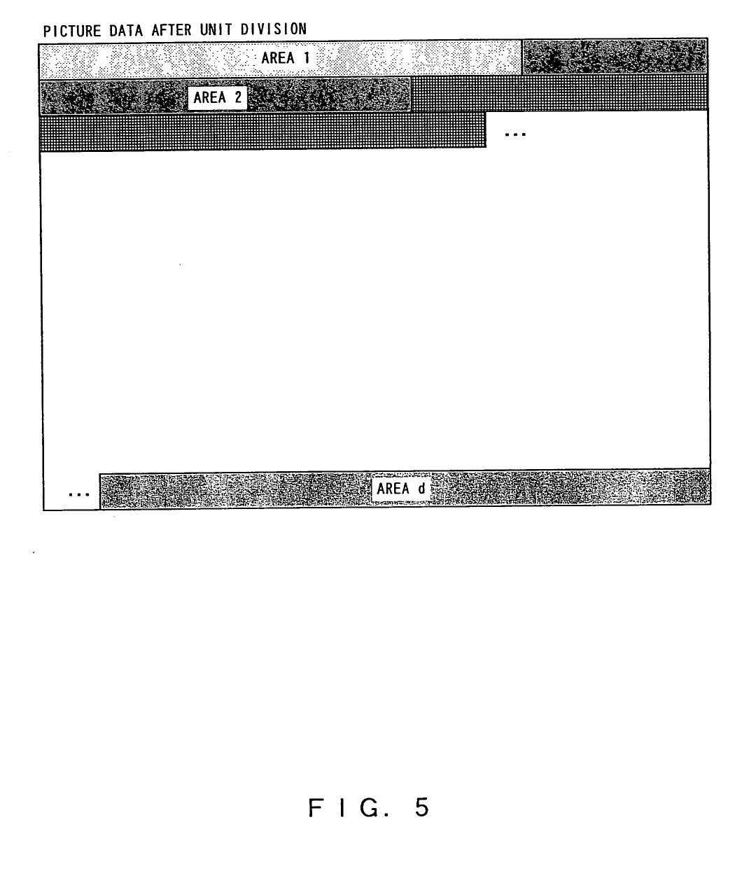

FIG. 5 shows an example of picture data obtained by dividing a picture composed of more number of pixels than the picture shown in FIG. 2. FIG. 5 includes a plurality of areas of an area 1, an area 2, . . . , an area d (d: a arbitrary positive number), which is described later.

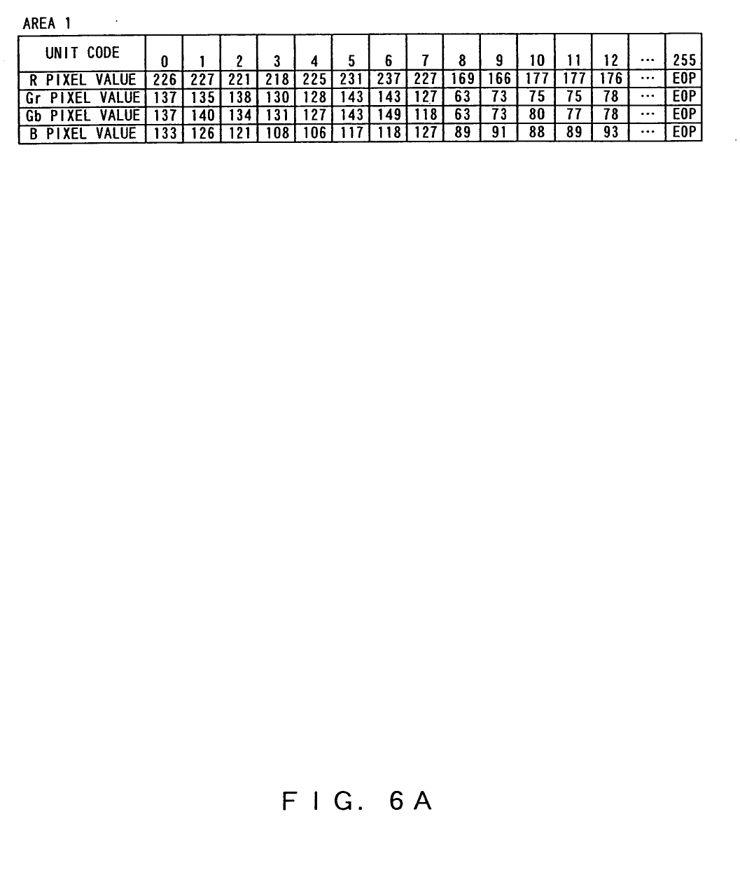

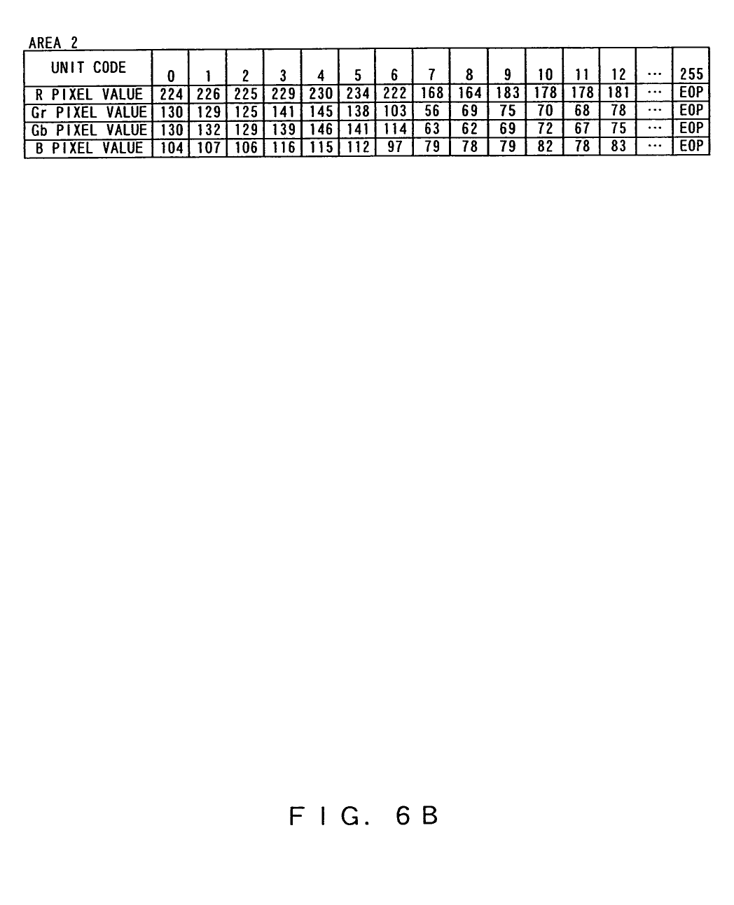

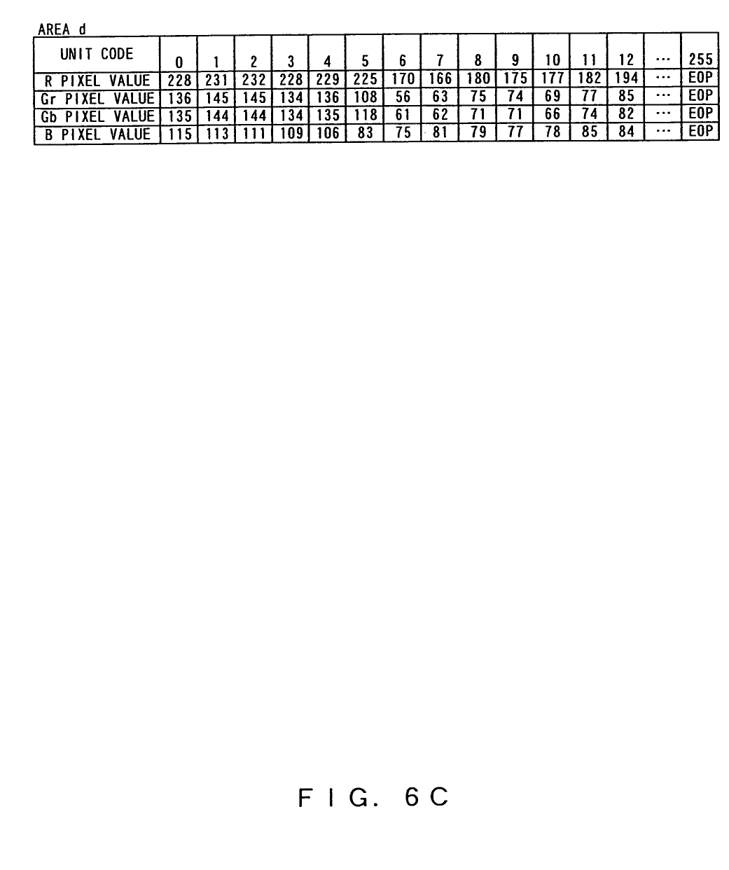

FIG. 6A shows palette data corresponding to the area 1 shown in FIG. 5. FIG. 6B shows palette data corresponding to the area 2 shown in FIG. 5.

FIG. 6C shows palette data corresponding to the area d shown in FIG. 5. Any area is composed of 255 patterns of pixel distributions to each of which one of unit codes 0˜254 is attached and EOP with a unit code 255.

The areas shown in FIGS. 5 and & 6A-6C are described below. For example, the number of unit codes that can be attached to one area can be determined beforehand. For example, if one unit code can be expressed by 8 bits, 256 (=2⁸) unit codes can be attached to one area. Since of the 256 unit codes, one is used for EOP, the remaining 255 unit codes can be used to be attached to pixel distributions. Specifically, a unit code can be attached to up to 255 patterns of pixel distributions. This range of a picture to which this unit code can be attached is handled as one area.

However, in the above-mentioned case, if the number of patterns of pixel distributions is over 255, no more unit code cannot be attached. In that case, the area is changed, in a new area, unit codes beginning with 0 are attached. As to this new area, if all unit codes are attached, as to a subsequent area, the same process is repeated. Thus, areas 1, 2, . . . , d are generated.

Therefore, the number of pixel distributions of the palette data of each area is unique and a unique unit code is attached to each of it. Then, EOP indicating the end of the area is stored in the unit code of the end of the palette data of each area.

In this case, if the number of patterns of pixel distributions of a specific area exceeds a predetermined number, the generation of palette data in the area is terminated, and palette data is generated in a subsequent area. Therefore, the higher is the appearance frequency of palette data the pattern of a pixel distribution of which is the same, the larger becomes the size of the area. Unit data corresponding to the palette data and area are also generated.

Although in the above description, unit division and palettization are performed using a Bayer picture as one example, the present invention is not limited to the Bayer picture, and a component picture, such as a general RGB full-color picture or the like can also be used.

The preferred embodiments of the compression/expansion of picture data using the present invention are described below.

### The First Preferred Embodiment

In this preferred embodiment, picture data is compressed (encoded) by dividing it into units, palettizing it and generating unit data and palette data.

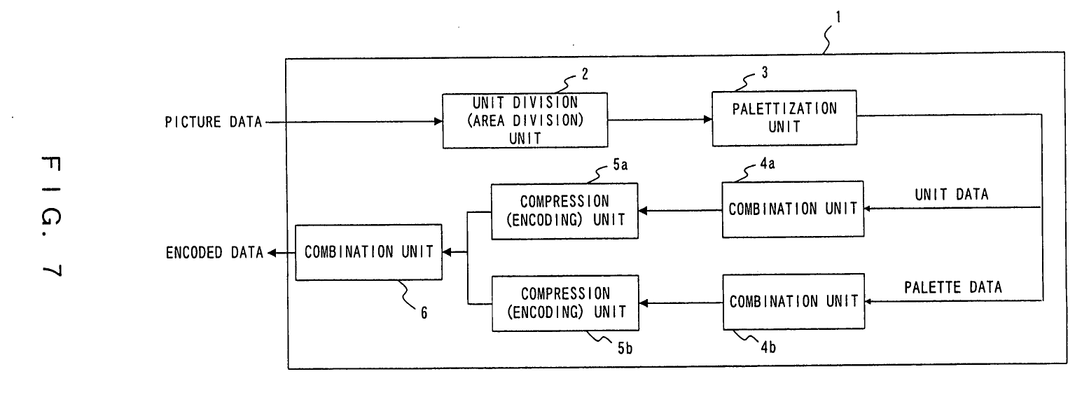

FIG. 7 shows the configuration of the picture compression apparatus in this preferred embodiment. A picture compression apparatus 1 comprises at least a unit-division (area division) unit 2, a palettization unit 3, combination units 4a, 4b and 6 and compression (encoding) unit 5a and 5b. The unit-division (area-division) unit 2 divides inputted picture data (performs a process corresponding to S1 in FIG. 1).

The palettization unit 3 generates palettization data. Specifically, the palettization unit 3 generates palette data and unit data (performs a process corresponding to S2 in FIG. 1). The palette data is obtained by attaching a unit code to each pattern of a unit pixel distribution. The unit data is obtained by replacing the unit picture data (FIG. 2) with a unit code (FIG. 3).

The combination unit 4a combines a plurality of pieces of unit data. As described with reference to FIGS. 6A-6C, since unit data is generated in each area, a plurality of pieces of such data are combined into one piece of data. This combination is performed by the existing method. The combination unit 4b combines a plurality of pieces of palette data. In this case too, palette data is generated in each area, a plurality of pieces of such palette data is combined into one piece of data.

The compression (encoding) unit 5a compresses (encodes) the palette data combined by the combination unit 4a. The compression (encoding) unit 5b compresses (encodes) the palette data combined by the combination unit 4b. The combination unit 6 combines the unit data and palette data compressed (encoded) by the compression (encoding) units 5a and 5b, respectively, into one piece of data (encoded data). For the compression (encoding), a variety of encoding methods can be used.

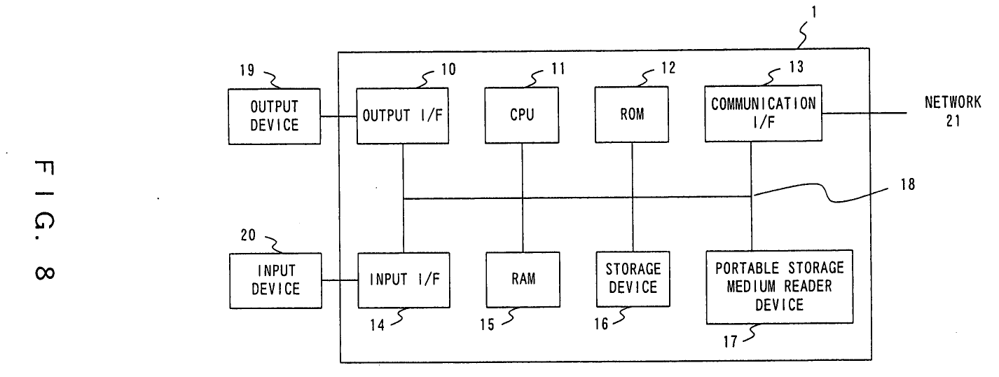

FIG. 8 shows one example of the hardware environment of the picture compression apparatus in this preferred embodiment. A picture compression apparatus 1 comprises, for example, an output interface (hereinafter an interface is called an “I/F”) 10, a central processing unit (CPU) 11, read-only memory (ROM) 12, a communication I/F 13, an input I/F 14, random-access memory (RAM) 15, a storage device 16, a portable storage medium reader device 17 and a bus 18 for connecting all units and devices to each other, an output device 19 connected to the output I/F 10 and an input device 20 connected to the input I/F 14.

For the storage device 16, a variety of types of storage devices, such as a hard disk, a magnetic disk and the like, can be used. In such a storage device 16 or ROM 12, programs shown in the following flowcharts are stored. The programs are read by the COU 11 and a programmed process is performed.

Such a program can also be stored in, for example the storage 16 from a program provider via the network 21 and communication I/F 13. Alternatively, if such a program is stored in a portable storage medium sold and distributed in the market, can be set in the reader device 17 and be executed by the CPU 11. For the portable storage medium, a variety of types of storage media, such as a CD-ROM, a flexible disk, an optical disk, a magneto-optical disk, an IC card, a DVD, a DVD-R, a DVD-RAM and the like, can be used. In that case, the program stored in such a storage medium is read by the reader device 17.

For the input device 20, a keyboard, a mouse, a tablet, a microphone, a camera/scanner for obtaining a picture or the like can be used. For the output device 19, a display, a printer, a speaker or the like can be used.

The network 21 can be the Internet, a LAN, a WAN, a dedicated line, and a wired/wireless communication network.

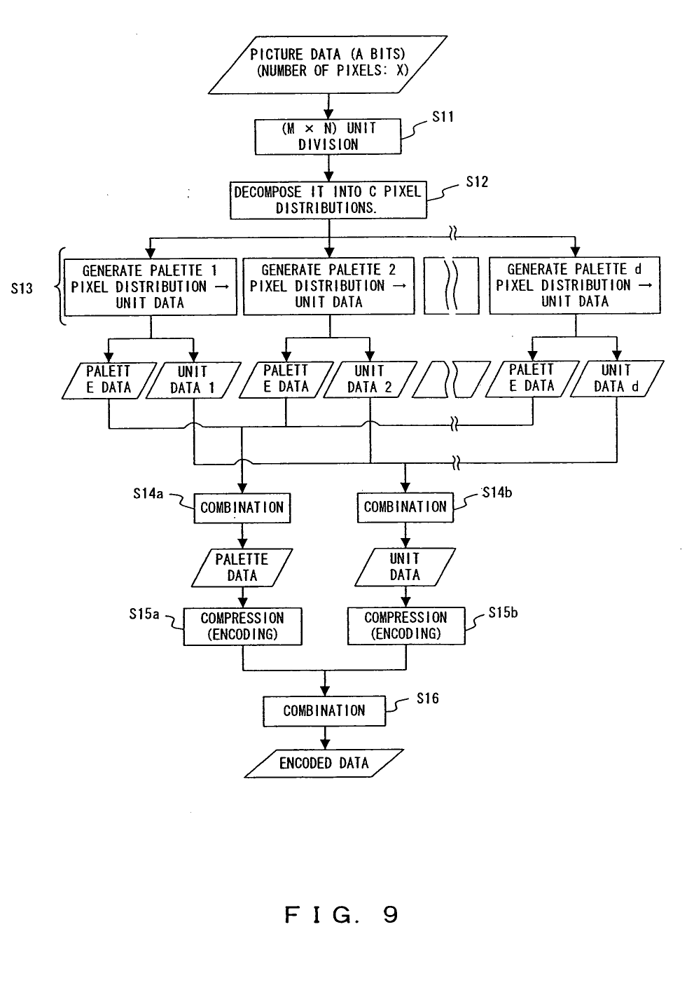

FIG. 9 is a flowchart showing the compression (encoding) process in this preferred embodiment. As picture data, a picture composed of x pixels, each of which is a bits, is used (a and x: arbitrary positive numbers). The picture data is stored in, for example, the storage device 16. Firstly, the picture data is read from the storage device by the CPU 16, and is divided into m×n units (S11). As described with reference to FIG. 2, this process divides the read picture data into units composed of a predetermined number of pixels (m vertical pixels×n horizontal pixels).

Then, each of c units is decomposed into pixel values constituting the unit (S12) (c: arbitrary positive number). As described with reference to FIGS. 5 and 6A-6C, one area contains c units each of which is composed of the predetermined number of pixel values (that is, c patterns of pixel values, and each of the c units composed of the predetermined number of pixel values is unique). As a result, a plurality of areas (in this preferred embodiment, areas 1, 2, . . . , d) and their corresponding palettization data are generated.

Then, palette generation is performed (S13). As described with reference to FIGS. 3 and 4, unit data is generated by expressing each piece of unit picture data using a corresponding unit code based on palette data generated in S12. In palette generation 1, 2, . . . , d palette generation is applied to areas 1, 2, . . . , d, respectively.

Then, the combination process of unit data (S14b) and the combination process of palette data (S14a) are performed. In the combination process of unit data (S14b), a plurality of pieces of unit data (d pieces of unit data) generated for each area in S13 is combined into one piece of data (hereinafter called “composed unit data). In the combination process of palette data (S14a), a plurality of pieces of palette data (d pieces of unit data) generated for each area in S13 is combined into one piece of data (hereinafter called “composed palette data).

Then, the compression (encoding) process of the combined unit data (S15b) and the compression (encoding) process of the combined palette data (S15a) are performed. As the compression (encoding) method, universal encoding, DPCM (Differential Pulse Code Modulation) encoding, run length encoding or the like is used. However, the compression (encoding) method is not limited to these methods.

Then, the compressed (encoded) combined unit data (hereinafter called “compressed combined unit data”) and the compressed (encoded) combined palette data (hereinafter called “compressed combined palette data”) are combined into one piece of data (encoded data) (S16). In this case, information about which part of the encoded data is the field of the compressed combined unit data (for example, how many bytes from the top of the encoded data), information about which part of the encoded data is the field of the compressed combined palette data (for example, field length, etc.) and other information needed to expand it are attached to the encoded data as header information.

Here, the flow terminates.

Since picture data has a high correlation with adjacent pixels, by doing so, adjacent units frequently take the same unit number. Thus, a compression rate can be improved. For example, since compression is performed by one of the universal encoding, DPCM encoding, run length encoding, the stronger a correlation with an adjacent pixel, the more the compression rate can be improved.

### The Second Preferred Embodiment

In this preferred embodiment, the encoded data compressed in the first preferred embodiment original picture data is reproduced by expanding it.

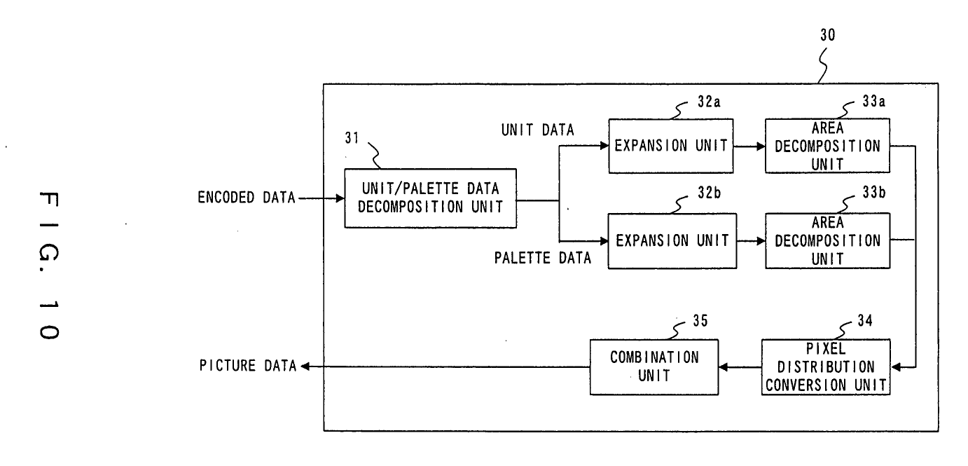

FIG. 10 shows the configuration of the picture reproduction apparatus in this preferred embodiment. A picture reproduction apparatus 30 comprises at least a unit/palette data division unit 31, expansion units 32a and 32b, area division units 33a and 33b, a pixel distribution conversion unit 34 and a combination unit 35.

The unit/palette data division unit 31 decomposes the encoded data generated in the first preferred embodiment into the compressed combined unit data and compressed combined palette data. The expansion unit 32a expands the compressed combined unit data into the combined unit data. The expansion unit 32b expands the compressed combined palette data into the combined palette data.

The area division unit 33a decomposes the combined unit data into unit data for each area. The area division unit 33a decomposes the combined palette data into palette data for each area. The pixel distribution conversion unit 34 reproduces pixels constituting the pixel distribution of palette data corresponding to this unit code, based on the unit code constituting unit data (each piece of picture data in each area can be reproduced). The combination unit 35 combines a plurality of pieces of picture data reproduced for each area into one piece of picture data. The configuration of the hardware environment of the picture reproduction apparatus 30 is the same as shown in FIG. 8.

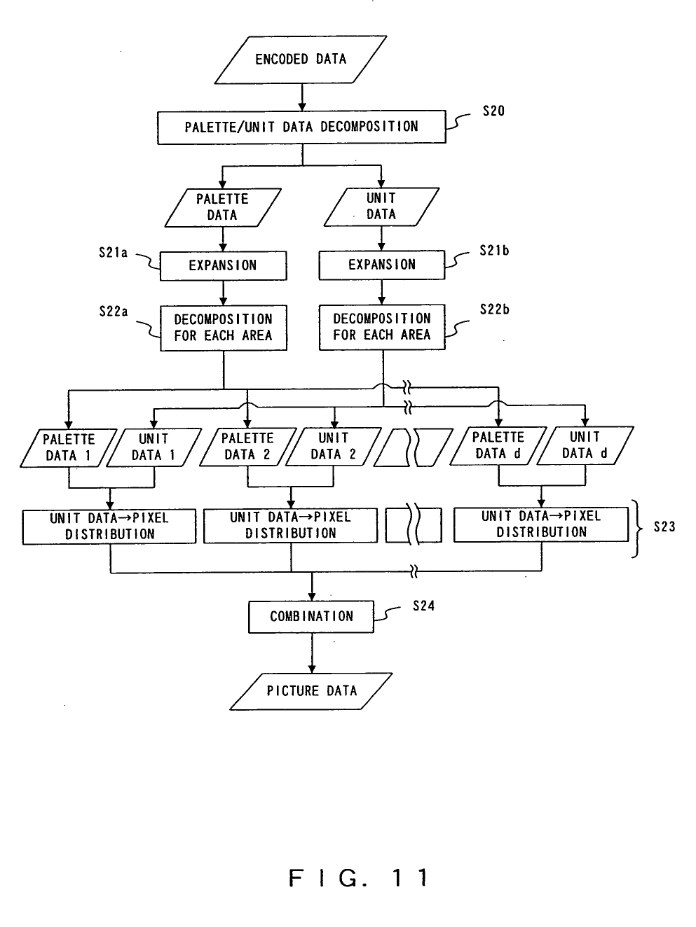

FIG. 11 is a flowchart showing an expansion process in this preferred embodiment. It is assumed that the encoded data is stored in, for example the storage device 16. Firstly, the encoded data is read from the storage device 16 by the CPU 11, and a unit/palette data division process (S20) is performed. This process decomposes the encoded data generated in the first preferred embodiment into the compressed combined unit data and the compressed combined palette data.

When dividing the data, firstly, the header information of the encoded data is checked. As described above, the header information contains information about which part of the encoded data is the field of the compressed combined unit data and information about which part of the encoded data is the field of the compressed combined palette data (for example, field length, etc.). The encoded data is decomposed into the compressed combined unit data and the compressed combined palette data based on the header information.

Then, the compressed combined palette data is expanded into combined palette data (S21a). The expansion is performed by a method corresponding to the compression (encoding). The compressed combined unit data is also expanded into combined unit data (S21b). The expansion is performed by a method corresponding to the compression (encoding).

Then, the combined palette data is decomposed into palette data for each area (S22a). In this case, for example, since a code (EOP) indicating the end of palette data is attached to the end of each piece of palette data constituting the combined palette data, it can also be detected and each piece of palette data can also be obtained. Alternatively, since unit codes, 0, 1, 2, . . . and so on are sequentially attached and they are attached again starting from 0 when an area changes, the first unit code of an area can be detected and each piece of palette data can also be obtained.

Then, the combined unit data is decomposed into unit data for each area (S22b). In this case, since a code (EOU) indicating the end of the unit data is attached to the end of each piece of unit data constituting the combined unit data, this can be detected, and each piece of unit data can also be obtained.

Then, pixels constituting the pixel distribution of palette data corresponding to this unit code is reproduced based on the unit code constituting the unit data (picture data corresponding to each area can be reproduced) (S23). Specifically, a picture corresponding to area 1 is reproduced using palette data 1 and unit data 1, a picture corresponding to area 2 is reproduced using palette data 2 and unit data 2, and lastly, a picture corresponding to area d is reproduced using palette data d and unit data d. Then, a plurality of pieces of picture data reproduced for each area is combined into one piece of picture data (S24). The decomposition in steps S20, S22a and S22b is only an example. Therefore, the decomposition method is not limited to this, and any publicly known method can be used.

By doing so, the data compressed (encoded) in the first preferred embodiment can be easily expanded to reproduce the original picture data.

### The Third Preferred Embodiment

This preferred embodiment is a variation of the first preferred embodiment, and bit division is further adopted in this preferred embodiment.

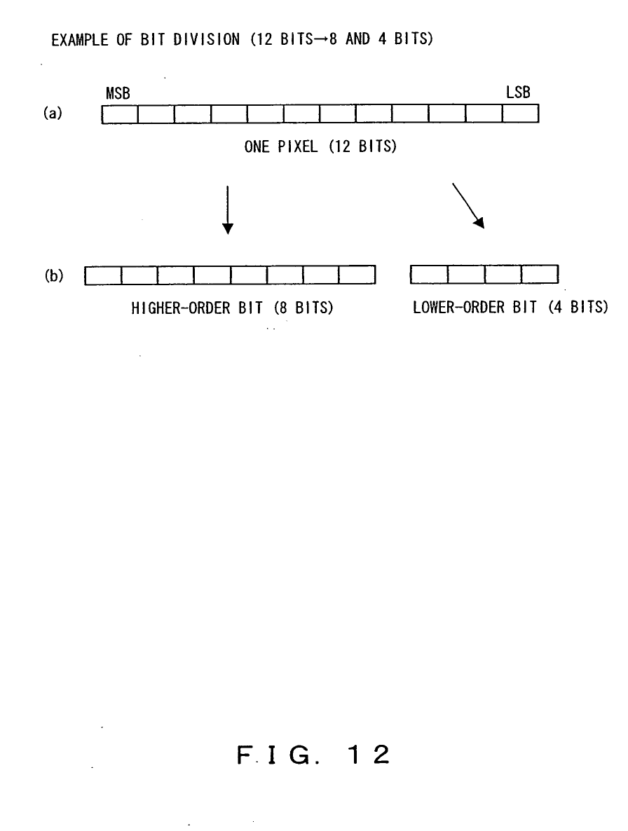

FIG. 12 shows one example of bit division in this preferred embodiment. In FIG. 12 (a), one pixel is composed of 12 bits, and the right and left ends indicate the most significant bit (MSB) and least significant bit (LSB), respectively. In FIG. 12 (b), these 12 bits are divided into 8 higher-order bits and 4 lower-order bits.

The advantage of this bit division is as follows. A Bayer picture shot by a digital camera or the like is expressed by 12-bit gradations, and the number of gradations is more than that of an ordinary full-colored picture. Of the 12 bits, the higher-order bits have a strong correlation with an adjacent pixel. Therefore, if the higher-order bits are extracted and the compression (encoding) of the first preferred embodiment is applied to them, the size of each area described with reference to FIG. 5 can be increased. As a result, the number of areas decreases, and the compression rate can be further improved. The compression (encoding) in this preferred embodiment is described below.

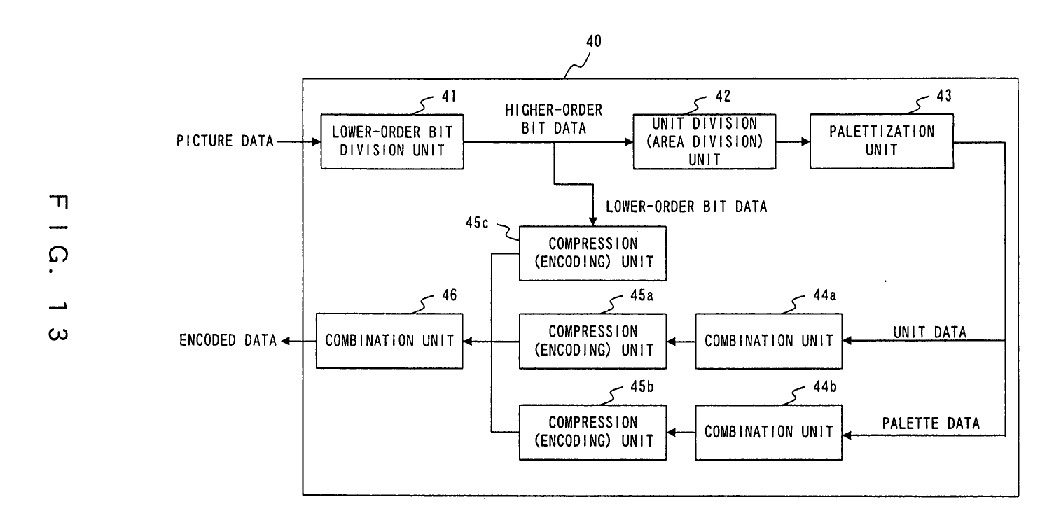

FIG. 13 shows the configuration of the picture compression apparatus 40 in this preferred embodiment. The picture compression apparatus 40 comprises a lower-order bit division unit 41, a unit-division (area-division) unit 42, a palettization unit 43, combination units 44a, 44b and 46 and compression (encoding) units 45a, 45b and 45c. As described with reference to FIG. 12, the lower-order division unit 41 divides bit data indicating each pixel constituting inputted picture data into higher-order bit data and lower-bit data.

The unit-division (area-division) unit 42 applies unit division to the higher-order bits, which is the output data of the lower-order bit division unit 41 to divide it into units (the same process as the unit division (area division) unit 2 shown in FIG. 7 is performed).

The palettization unit 43 generates palettization data. Specifically, the palettization unit 43 generates palette data and unit data (performs the same process as that of the palettization unit 3 shown in FIG. 7). The palette data is obtained by attaching a unit code to each pattern of unit pixel distribution. The unit data is obtained by expressing the unit picture data by this unit code.

The combination unit 44a combines a plurality of pieces of unit data (performs the same process as that of the combination unit 4a shown in FIG. 7). The combination unit 44b combines a plurality of pieces of palette data (performs the same process as that of the combination unit 4b shown in FIG. 7).

The compression (encoding) unit 45a compresses (encodes) the unit data combined by the combination unit 44a (performs the same process as that of the compression (encoding) unit 5a shown in FIG. 7). The compression (encoding) unit 45b compresses (encodes) the palette data combined by the combination unit 44b (performs the same process as that of the compression (encoding) unit 5b shown in FIG. 7). The compression (encoding) unit 45c compresses (encodes) the lower-order bit data outputted from the lower-bit division unit 41.

The combination unit 46 combines the unit data, palette data and lower-order bit data which are compressed (encoded) by the compression (encoding) unit 45a, 45b and 45c, respectively, into one piece of data (encoded data). The configuration of the hardware environment of the picture compression apparatus is the same as shown in FIG. 8.

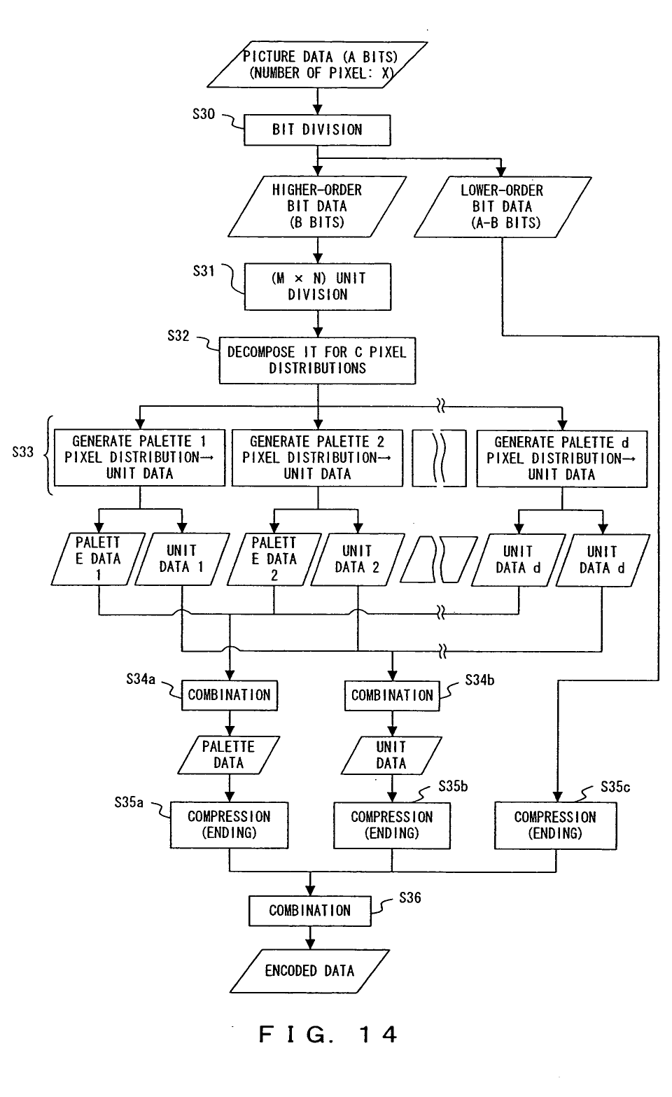

FIG. 14 is a flowchart showing the compression (encoding) process in this preferred embodiment. As picture data, a picture composed of x pixels, each of which is a bits, is used (a and x: arbitrary positive numbers). The picture data is stored in, for example, the storage device 16. Firstly, the picture data is read from the storage device 16 by the CPU 11, bit division is applied to each pixel (S30). The bit division is as per described with reference to FIG. 12. In this embodiment, each pixel is divided into b bits (b: arbitrary positive number, b<a) of higher-order bit data and (a-b) bits of lower-order bit data. The number b of divided bits can be preset.

Then, unit division is applied to the higher-order bit data (b bits) (S31). This process is the same as S11 shown in FIG. 9.

Then, each of c pixel distributions is decomposed into pixels constituting the pixel distribution (S32) This process is the same as S12 shown in FIG. 9.

Then, palette generation is performed (S33). This process is the same as S13 shown in FIG. 9.

Then, the combination process of unit data (S34b) and the combination process of palette data (S34a) are performed. These processes are the same as S14b and S14a, respectively, shown in FIG. 9. Hereinafter, unit data combined in S34b and palette data combined in S34a are called combined unit data and palette data, respectively.

Then, the compression (encoding) process of the combined unit data (S35b) and the compressed (encoding) process of the combined palette data (35a) are performed. For each of these processes, for example, universal encoding, DPCM coding, run length encoding or the like is used as in S15b and S15a, respectively, shown in FIG. 9. However, the compression (encoding) method is not limited to them.

A compression (encoding) process is also applied to the lower-order bit data ((a-b) bits) divided in S30 (S35c). In this case, compression (encoding), such as universal encoding, DPCM encoding, run length encoding or the like is used as in S35a and S35b. However, the compression (encoding) method is not limited to them.

Then, the compressed (encoded) combined unit data (hereinafter called “compressed combined unit data”), compressed (encoded) combined palette data (hereinafter called “compressed combined palette data”) and compressed (encoded) lower-order bit data (hereinafter called “compressed lower-order bit data) are combined into one piece of data (encoded data) (S36). In this case, information about which part of the encoded data is the field of the compressed combined unit data (for example, an offset from the top of the encoded data), information about which part of the encoded data is the field of the compressed combined palette data, information about which part of it is the field of the compressed lower-order bit data (for example, field length, etc.), information about bit division (for example, the value of a, etc.) and other information needed to expand it are attached to the encoded data as its head information.

Thus, the flow terminates.

By doing so, since compression can be performed separating the lower-order bid data susceptive of the influence of the noise of picture data, the compression rate can be further improved. Specifically, since units very often take the same unit code by attaching a unit code to a higher-order bit, the compression rate can be further improved. Thus, since higher-order bits having a strong correlation with an adjacent pixel can be compressed together, compression efficiency can be improved.

Alternatively, not only higher-order bits but also lower-order bits having a correlation can be compressed. In this case, since at least one of universal encoding, DPCM encoding, run length encoding and the like is used, the stronger the correlation with an adjacent pixel is, the more the compression rate can be improved.

### The Fourth Preferred Embodiment

In this preferred embodiment, the original picture data can be reproduced by expanding the encoded data compressed in the third preferred embodiment.

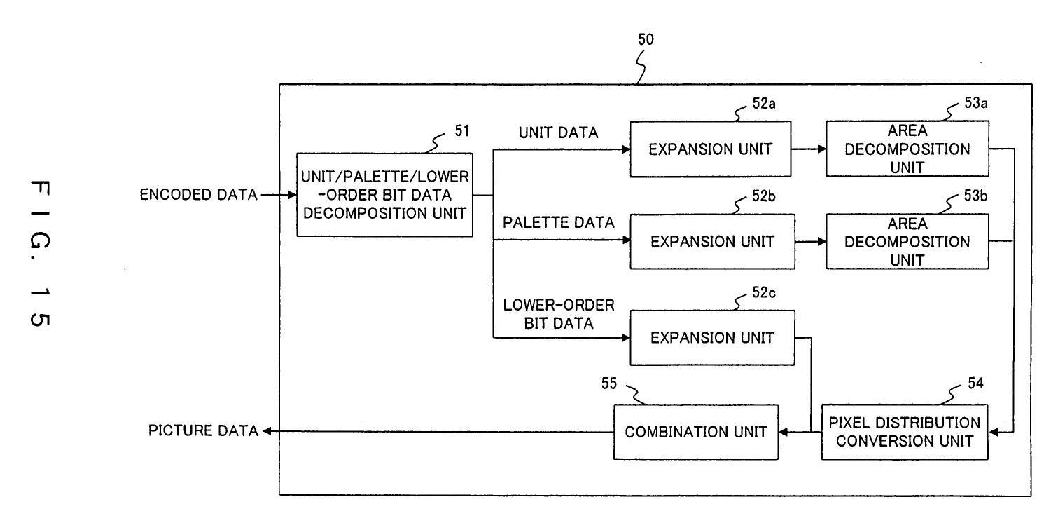

FIG. 15 shows the configuration of the picture reproduction apparatus in this preferred embodiment. A picture reproduction apparatus 50 comprises a unit/palette/lower-order bit data decomposition unit 51, expansion units 52a, 52b and 52c, area division unit 53a and 53b, a pixel distribution conversion unit 54 and a combination unit 55.

The unit/palette/lower-order bit data decomposition unit 51 decomposes the encoded data generated in the third preferred embodiment into the compressed combined unit data, compressed combined palette data and compressed lower-order bit data.

The expansion unit 52a expands the compressed combined unit data into combined unit data. The expansion unit 52b expands the compressed combined palette data into combined palette data. The expansion unit 52c expands the compressed lower-order bit data into lower-order bit data.

The area decomposition unit 53a decomposes the combined unit data into a plurality of pieces of unit data for each area. The area decomposition unit 53b decomposes the combined palette data into a plurality of pieces of palette data for each area. The pixel distribution conversion unit 54 reproduces the pixels of palette data (pixels of higher-order bit data) corresponding to this unit code, based on the unit code constituting the unit data (picture data for one area is reproduced).

The combination unit 55 combines a plurality of pieces of picture data of the higher-order bit data reproduced for each area into one piece of picture data (picture data of the higher-order bit data). Then, the higher-order bit data (b bits) and lower-order bit data ((a-b) bits) of each pixel of the picture data are combined to reproduce picture data one pixel of which is composed of ‘a’ bits. The configuration of the hardware environment of the picture reproduction apparatus 50 is the same as that of FIG. 8.

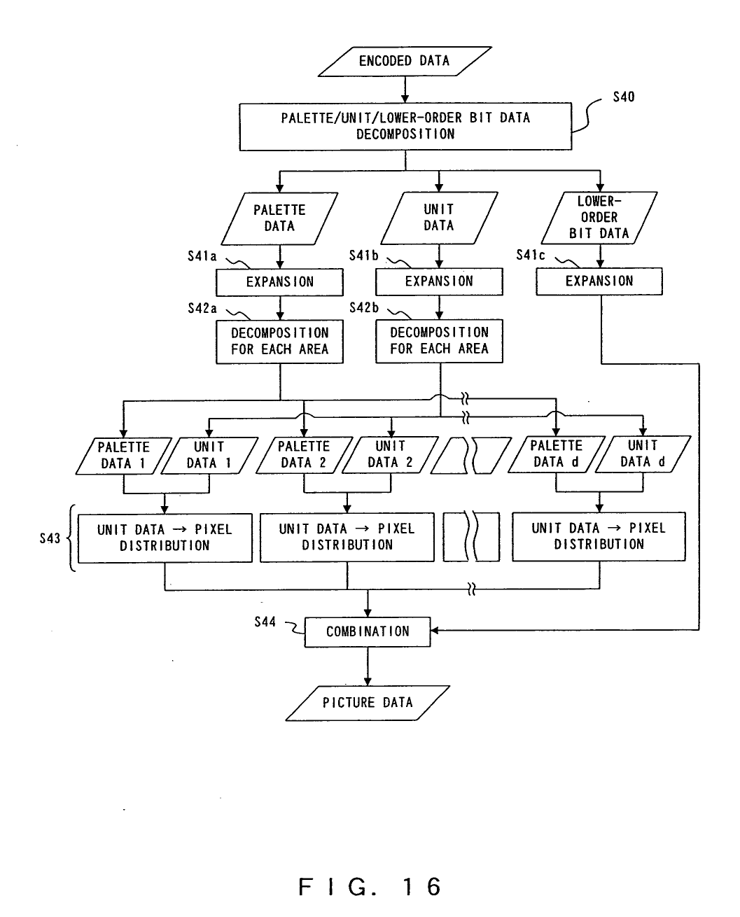

FIG. 16 is a flowchart showing the expansion process in the fourth preferred embodiment. It is assumed that the encoded data is stored in, for example, the storage device 16. Firstly, the encoded data is read from the storage device 16 by the CPU 11, and unit/palette/lower-order bit data decomposition is performed (S40).

In this process, the encoded data generated in the third preferred embodiment is decomposed into compressed combined unit data, compressed combined palette and compressed lower-order bit data. This process is the same as S20 of FIG. 11, and decomposes the encoded data into compressed combined unit data, compressed combined palette and compressed lower-order bit data based on the header information of the encoded data.

Then, the compressed combined palette data is expanded into combined palette data (S41a). The expansion is performed by a method corresponding to the compression (encoding). The compressed combined unit data is also expanded into combined unit data (S41b). The expansion is performed by a method corresponding to the compression (encoding). These processes are the same as S21a and S21b, respectively, of FIG. 11.

The compressed lower-order bit data is also expanded into lower-order bit data (S41c). The expansion is performed by the same method as S21a or S21b.

Then, the combined palette data is decomposed into palette data for each area (S42a). This process is performed by the same method as S22a of FIG. 11. The combined unit data is decomposed into unit data for each area (S22b). This process is performed by the same method as S22b of FIG. 11.

Then, the pixels of the pixel distribution of palette data corresponding to this unit code is reproduced based on the unit code constituting the unit data (picture data corresponding to each area (picture data for only the higher-order bits) is reproduced) (43) This process is the same as S23 of FIG. 11.

Then, a plurality of pieces of picture data of the higher-order bit data reproduced for each area is combined into one piece of picture data (picture data of the higher-order bit data). Then, the higher bit data (b bits) and lower-order bit data ((a-b) bits) of each pixel of the picture data are combined to reproduce picture data where every pixel is composed of ‘a’ bits (S44).

By doing so, the encoded data compressed in the third preferred embodiment can be easily expanded to reproduce the original picture data.

AS described above, according to the present invention, overlapping existing color components among color components representing the same color can be eliminated when reversibly compressing a picture with a plurality of color components, thereby improving a compression rate.

1. A picture compression apparatus, comprising:
a division device for dividing picture data composed of a plurality of two-dimensionally arrayed pixels into units composed of m×n (m and n: arbitrary positive numbers) pixels;
a unit code attaching device for attaching a same code to the unit if the pixel value of each color component in the unit is the same, and for attaching a different code to the unit if the pixel value of each color component in the unit is different; and
a compression device for applying a predetermined compression process to pixel data corresponding to a unit code attached by the unit code attaching device and the unit code.

2. A picture compression apparatus, comprising:
a division device for dividing picture data into units composed of a predetermined number of pixels;
a palette data generation device for generating palette data containing the pixel value of each color component in the unit and a unit code attached according to its distribution;
a unit data generation device for generating unit data in which the picture data divided into units is expressed by a unit code corresponding to the pixel value of each color component of the unit; and
a compression device for compressing the palette data and the unit data.

3. The picture compression apparatus according to claim 2, further comprising
a pixel data division device for dividing each pixel piece of data which constitutes the picture data and is composed of a predetermined number of bits into higher-order pixel data composed of higher-order bits and lower-order pixel data composed of lower-order bits,
wherein
the pallet data generation device generates higher-order palette data which is the palette data of the picture data, composed of the higher-order pixel data.

4. The picture compression apparatus according to claim 3, wherein
the compression device compresses the lower-order pixel data.

5. The picture compression apparatus according to claim 2, wherein
the compression device performs the compression using at least any one of universal encoding, DPCM encoding and run length encoding.

6. The picture compression apparatus according to claim 3, wherein
the compression device compresses the higher-order pixel palette data using at least any one of universal encoding, DPCM encoding and run length encoding.

7. The picture compression apparatus according to claim 4, wherein
the compression device compresses the lower-order pixel data using at least any one of universal encoding, DPCM encoding and run length encoding.

8. A reproduction apparatus, comprising:
an expansion device for dividing picture data composed of a plurality of two-dimensionally arrayed pixels into units composed of m×n (m and n: arbitrary positive numbers) pixels, and attaching a same code to the unit if the pixel value of each color component in the unit is the same, and a different code to the unit if the pixel value of each color component in the unit is different, and expanding compressed data in which a predetermined compression process is applied to pixel data corresponding to the attached unit code and the unit code; and
a reproduction device for reproducing the picture data, based on the unit code expanded by the expansion device and pixel data corresponding to the unit code.

9. A reproduction apparatus, comprising:
an expansion device for dividing picture data into units composed of a predetermined number of pixels, generating palette data containing the pixel value of each color component of the unit and a unit code attached according to its distribution, generating unit data in which the picture data divided into units is expressed by a unit code corresponding to the pixel value of each color component of the unit and expanding data obtained by compressing the palette data and the unit data; and
a reproduction device for reproducing the picture data, based on the palette data and the data which are expanded by the expansion device.

10. A reproduction apparatus, comprising:
an expansion device for dividing each piece of pixel data which constitutes picture data and is composed of a predetermined number of bits into higher-order pixel data composed of higher-order bits and lower-order pixel data composed of lower-order bits, dividing the picture data into units composed of a predetermined number of pixels, generating higher-order pixel palette data containing the pixel value of each higher-order color component of the unit and a unit code attached according to its distribution, generating higher-order pixel unit data in which the picture data divided into units is expressed by a unit code corresponding to the pixel value of each higher-order color component of the unit and expanding data obtained by compressing the higher-order palette data and the higher-order unit data; and
a reproduction device for reproducing the picture data, based on the higher-order pixel palette data, the higher-order pixel unit data and the lower-order pixel data.

11. A reproduction apparatus, comprising:
an expansion device for dividing each piece of pixel data which constitutes picture data composed of a predetermined number of bits into higher-order pixel data composed of higher-order bits and lower-order pixel data composed of lower-order bits, dividing the picture data into units composed of a predetermined number of pixels, generating higher-order pixel palette data containing the pixel value of each higher-order color component of the unit and a unit code attached according to its distribution, generating higher-order pixel unit data in which the picture data divided into units is expressed by a unit code corresponding to the pixel value of each higher-order color component of the unit and expanding data obtained by compressing the higher-order palette data, the higher-order unit data and the lower pixel data; and
a reproduction device for reproducing the picture data, based on the higher-order pixel palette data, the higher-order pixel unit data and the lower-order pixel data.

12-19. (canceled)

20. A computer-readable storage medium on which is recorded a program for enabling a computer to compress a picture, said program comprising:
dividing picture data composed of a plurality of two-dimensionally arrayed pixels into units composed of m×n (m and n: arbitrary positive numbers) pixels;
attaching a same code to the unit if the pixel value of each color component in the unit is the same, and for attaching a different code to the unit if the pixel value of each color component in the unit is different; and
applying a predetermined compression process to pixel data corresponding to a unit code which is the attached code and the unit code.

21. A computer-readable storage medium on which is recorded a program for enabling a computer to compress a picture, said program comprising:
dividing picture data into units composed of a predetermined number of pixels;
generating palette data containing the pixel value of each color component in the unit and a unit code attached according to its distribution;
generating unit data in which the picture data divided into units is expressed by a unit code corresponding to the pixel value of each color component of the unit; and
compressing the palette data and the unit data.

22. A computer-readable storage medium on which is recorded a program for enabling a computer to reproduce a picture, said program comprising:
dividing picture data composed of a plurality of two-dimensionally arrayed pixels into units composed of m×n (m and n: arbitrary positive numbers) pixels, and attaching a same code to the unit if the pixel value of each color component in the unit is the same, and a different code to the unit if the pixel value of each color component in the unit is different, and expanding compressed data in which a predetermined compression process is applied to pixel data corresponding to the attached unit code and the unit code; and
reproducing the picture data, based on the expanded unit code and pixel data corresponding to the unit code.

23. A computer-readable storage medium on which is recorded a program for enabling a computer to reproduce a picture, said program comprising:
dividing picture data into units composed of a predetermined number of pixels, generating palette data containing the pixel value of each color component of the unit and a unit code attached according to its distribution, generating unit data in which the picture data divided into units is expressed by a unit code corresponding to the pixel value of each color component of the unit and expanding data obtained by compressing the palette data and the unit data; and
reproducing the picture data, based on the expanded palette data and the expanded unit data.

24-29. (canceled)
